(19) United States
(12) Patent Application Publication
(10) Pub. No.: US 2017/0372397 A1
(43) Pub. Date: Dec. 28, 2017

(54) SYSTEM AND METHOD FOR CONSUMER CHOICE MODELING

(71) Applicants: Rachel Law, New York, NY (US); Jonathan R. Baldwin, New York, NY (US)

(72) Inventors: Rachel Law, New York, NY (US); Jonathan R. Baldwin, New York, NY (US)

(21) Appl. No.: 15/189,817

(22) Filed: Jun. 22, 2016

(51) Int. Cl. G06Q 30/06; G06Q 10/06; G06F 3/01

(52) U.S. Cl. CPC G06Q 30/0625; G06F 3/017; G06Q 10/067

(57) ABSTRACT

A method is provided, comprising steps (a) providing a search query to a user, wherein the user enters an item into the search query; (b) presenting the user with a consumer choice model, wherein the consumer choice model is a three choice model comprising a first container block having first item, a second item, and a third item; (c) navigating through a plurality of three choice models via a plurality of commands; and (d) selecting an item.

### CROSS-REFERENCE TO RELATED APPLICATIONS

N/A

### BACKGROUND OF THE INVENTION

### 1. Field of the Invention

The present invention relates to a system and method for consumer choice modeling, and more specifically a system and method for a consumer three-choice model.

### 2. Description of Related Art

Consumers are provided an abundance of options every day, and most consumers have a difficult time deciding between their available options. This is especially true when consumers feel overwhelmed with the number of options available. Consequently, there is a need for a consumer choice model assisting users to decide between options.

### BRIEF SUMMARY OF THE INVENTION

In one embodiment of the present invention a method is provided, comprising steps: (a) providing a search query to a user, wherein the user enters an item into the search query; (b) presenting the user with a consumer choice model, wherein the consumer choice model is a three choice model comprising a first container block having first item, a second item, and a third item; (c) navigating through a plurality of three choice models via a plurality of commands; and (d) selecting an item.

In one embodiment, the item may be a choice the user is deciding between including but not limited to products, objects, actions, persons, or interactive cards. In another embodiment, the consumer choice model may be presented in a plurality of layouts, wherein the plurality of layouts include a stream layout, a grid layout, a stack layout, and a stack layout with hidden series. In one embodiment, any of the plurality of layouts may be selected by the user. In yet another embodiment, the plurality of commands includes direct navigational commands and modifier commands. In one embodiment, direct navigational commands allow the user to navigate between the plurality of three choice models, wherein navigational commands comprises text commands and gesture commands. In one embodiment, the modifier commands includes text commands to narrow down a potential range of options, limiting the plurality of three choice models to include items which match the potential range of options.

In one embodiment, a further step is provided, saving data points forming a user history profile, wherein the user history includes a history of the plurality of three choice models which were presented to the user and the data points are saved to a data repository on an Internet-connected server. In another embodiment, the user history profile may be viewed, edited, shared, linked, saved, referred, and sent to other users. In one embodiment, the consumer choice model is defined by an algorithm, wherein the algorithm is based on a plurality of factors included but not limiting to the user's purchase history, product reviews, product ratings, product details, price points, other user search results, and randomization. In yet another embodiment, the selected item may be purchased.

In another aspect of the invention, a system is provided comprising an Internet-connected computerized appliance having a processor and coupled to a data repository, the processor executing software from a non-transitory medium, the software providing an interactive interface to a consumer choice model, the system enabling a user to: search for an item; navigate through a plurality of three choice models via navigational commands; narrow down potential options of the plurality of three choice models using modifier commands; save search history into a user history profile; and select an item.

In one embodiment, the item may be a choice the user is deciding between including but not limited to products, objects, actions, persons, or interactive cards. In another embodiment, the consumer choice model may be presented in a plurality of layouts, wherein the plurality of layouts include a stream layout, a grid layout, a stack layout, and a stack layout with hidden series, wherein any of the plurality of layouts may be selected by the user. In one embodiment, the selected item may be purchased.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is an architectural diagram of an Internet computer network system according to an embodiment of the present invention.

FIGS. 2A-B are exemplary diagrams illustrating methods for consumer choice modeling according to an embodiment of the present invention.

FIGS. 3A-D are exemplary diagrams illustrating methods for consumer choice modeling navigation according to an embodiment of the present invention.

FIGS. 4A-D are exemplary diagrams illustrating methods for consumer choice modeling layouts according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out their invention. Various modifications, however, will remain readily apparent to those skilled in the art, since the general principles of the present invention have been defined herein to specifically provide a system and method for consumer choice modeling.

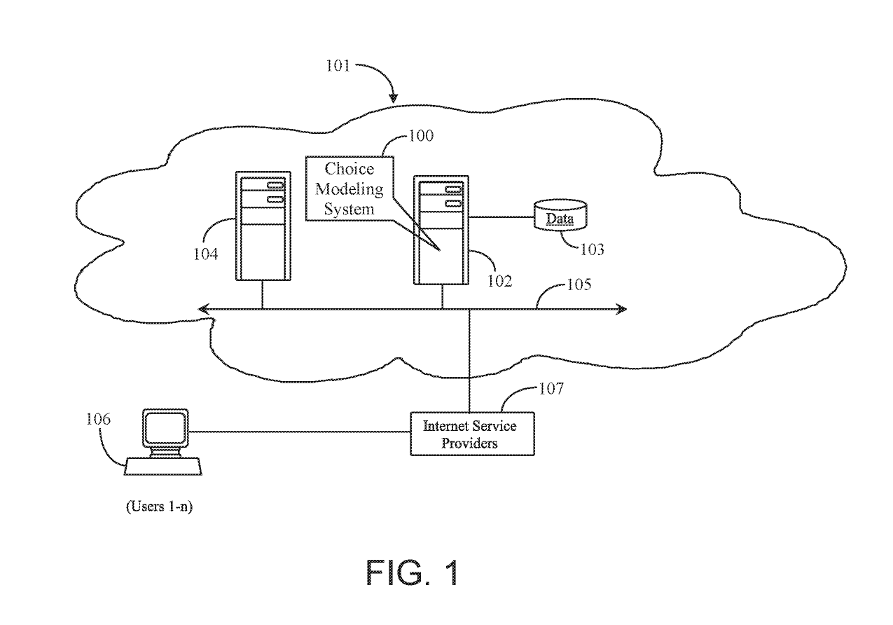

FIG. 1 is an architectural diagram of an Internet 101 computer network system according to an embodiment of the present invention. The Internet-connected system comprises one or more Internet-connected servers 102 executing a system for choice modeling 100 from non-transitory media. Server 102 is connected to a data repository 103, which may be any sort of data storage known in the art. The system further comprises a third party Internet-connected server 104 connected to Internet backbone 105. Although one third party Internet-connected server 104 is shown, it is understood that potentially millions of other similar servers are connected to the Internet via Internet backbone 105. A number of users (1-n) 106 on a computerized device are connected to the Internet-connected server via an Internet service provider (ISP) 107, allowing users 106 to access the system. Users are defined as individual persons, individual channels within channels within a larger chat platform, a self-identified group under the same name, a single team working professionally or semi-professionally together, or a single department within a corporation or a single corporate entity. The users may access the system with a computerized device, including but not limited to a personal computer, tablet, or mobile device.

In one embodiment, the system for choice modeling is a three choice model. The three choice model may contain up to three items, wherein the items may be defined as products, objects, actions, persons, interactive cards, containers, or other information corresponding to anything a user may be decided between. The system is designed to aid the users in a decision-making process. As previously mentioned, the system is provided to users via the Internet computer network system, and the system and corresponding items may be presented via an image, an attachment, or a message body via email, text, chat window, touchscreen, or any other format allowing the system to aid the users in the decision-making process.

It is a particular advantage of the present invention to provide a limited, curated, simplified personalized set of choices to the users in an intuitive, accessible, and easy to use method. The method is used consistently in the system throughout all user interactions, allowing users to modify, adjust, or customize each choice to produce new choices within the same format. This will be described in greater detail below.

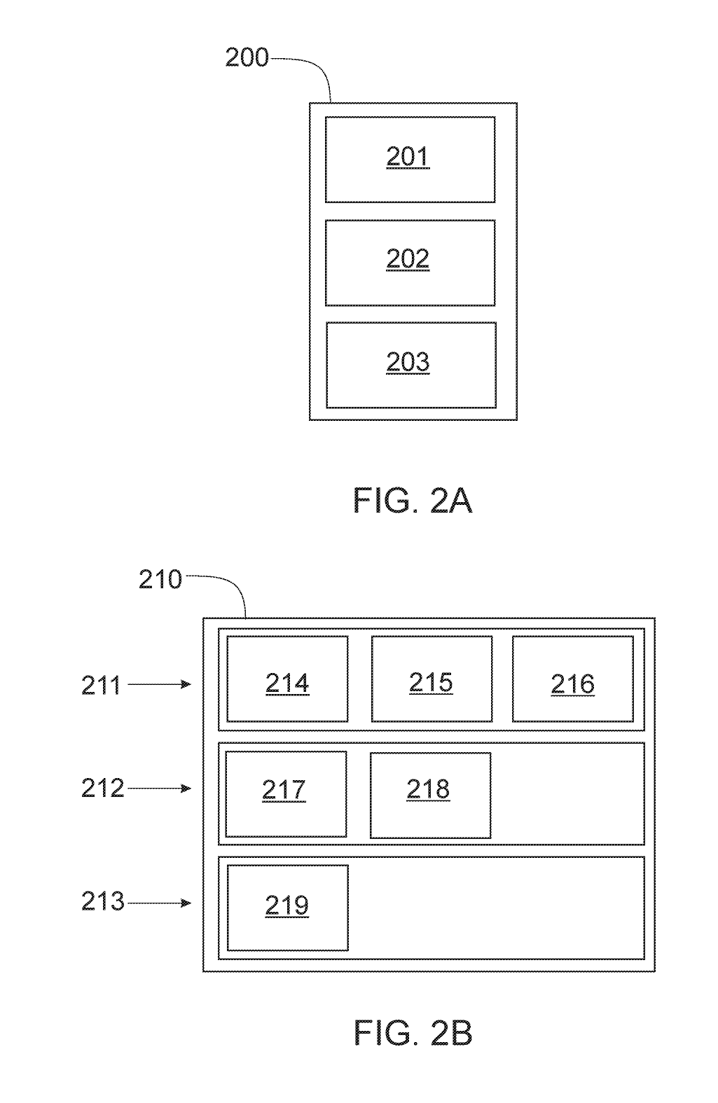

FIGS. 2A-B are exemplary diagrams illustrating methods for consumer choice modeling according to an embodiment of the present invention. Referring now to FIG. 2A, a first consumer model 200 is illustrated. The first consumer model illustrates how three items may be presented to the users. The three items include a first item 201, a second item 202, and a third item 203. As previously mentioned, the items may be products, objects, actions, persons, interactive cards, containers, or other information corresponding to anything a user may be deciding between. Referring now to FIG. 2B, a second consumer model 210 is illustrated. The second consumer model illustrates an alternative embodiment how items may be presented to the users. In this embodiment, three rows may be provided 211, 212, and 213. Each row may feature one to three items. For instance, first row 211 features three items 214/215/216, second row 212 features two items 217/218, and third row 213 features one item 219. These consumer models illustrated in FIGS. 2A-B, generally represent how items are presented to users in the system. The details of how users may navigate between items will be described below.

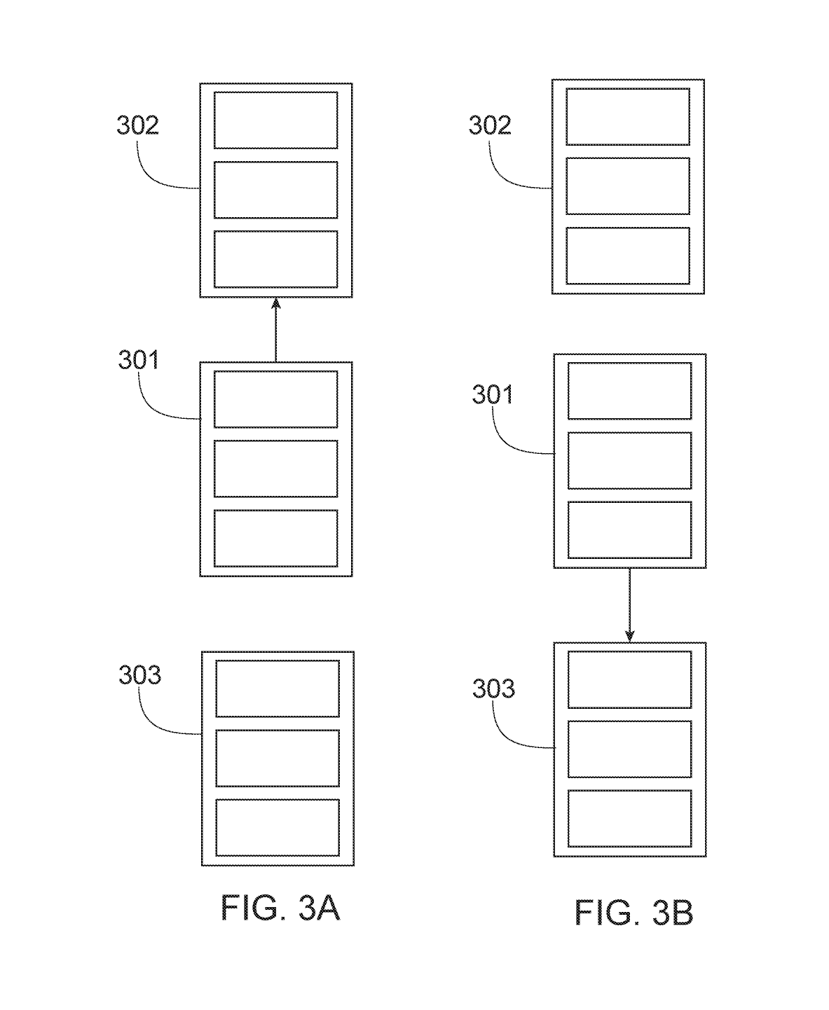

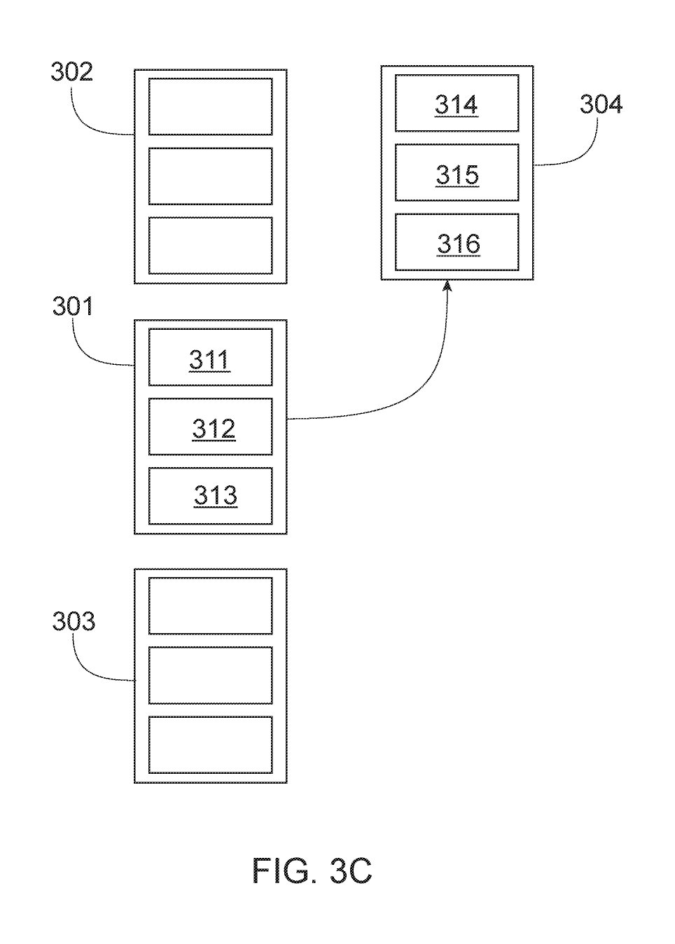

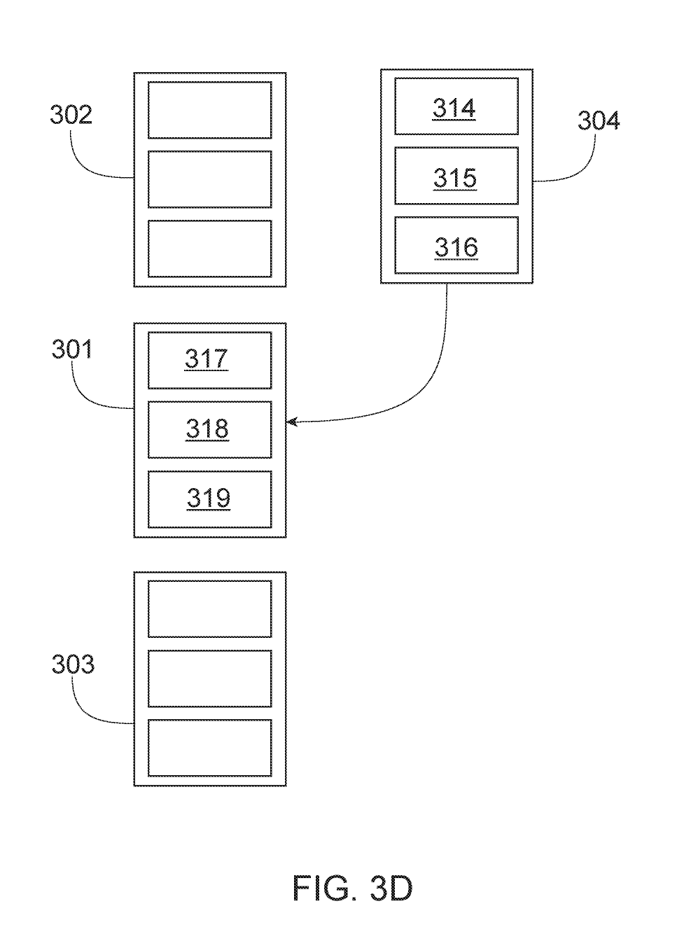

FIGS. 3A-D are exemplary diagrams illustrating methods for consumer choice modeling navigation according to an embodiment of the present invention. Referring now to FIG. 3A, a user may navigate, and specifically advance between consumer choice models by a plurality of commands. For instance, consumer choice model or container block 301 represents the current consumer choice model the user is presented, featuring three items (as illustrated in FIG. 2A). The user may advance to the next container block 302 by the plurality of commands, including but not limited to text and gesture commands. An exemplary text command, “more” would shift the consumer choice model from container block 301 to container block 302. It is understood that similar text commands may be utilized for navigational purposes, and “more” is simply an example of a potential navigational text command. If a user is accessing the system from a mobile device or a computerized device that provides touch screen capabilities, a gesture command such as swiping left, may be utilized to advance to the next container block as illustrated. Likewise, the user may navigate to the previous consumer choice model or container block by using text and gesture commands.

Referring now to FIG. 3B, the user may navigate and shift the consumer choice model from container block 301 to container block 303 by utilizing the plurality of commands. Container block 303 represents a previous consumer choice model that the user was previously presented prior to the current container block 301. An exemplary text command, “back” would shift the consumer choice model from container block 301 to the previous container block 303. It is understood, that similar text commands may be utilized for navigational purposes, and “back” is simply an example of a potential navigational text command. If a user is accessing the system from a mobile device or a computerized device that provides touch screen capabilities, a gesture command such as swiping right, may be utilized to revert to the previous container block as illustrated.

It is a particular advantage of the present invention to provide a consumer choice model featuring three choices defined by an algorithm. The algorithm is based on a variety of factors, including but not limited to a user's purchase history, product reviews, product ratings, product details, price points, other user search results, randomization, and other factors based on the type of request received. Price points are based on three different aggregates: 40%, 60%, and 80%. The product reviews, ratings, and details are captured by crowdsourcing. Other user search results include information such as other user search and purchase history.

During operation, a user may provide the system a request. For instance, if the user is interesting in purchasing a new item, such as a dress, the user may request to the system to search for a dress. The system will present the user with a consumer choice model (FIG. 2A) based on the aforementioned algorithm. Next, the user may navigate through a series of consumer choice model container blocks as described above and illustrated in FIGS. 2C-D. At any time the user may request a modifier to the method. The modifier enables the system to provide the user with a new consumer choice model based on the specific modifier. This will be described in greater detail below.

Referring now to FIG. 3C, the user may add a modifier as described above. For instance, consumer choice model or container block 301 containing items 311, 312, and 313 representing dress options in this exemplary instance. The user may be interested in item 311, but will request the system to narrow down the range of options by adding a modifier. If item 311 represented a specific dress type, such as a cocktail dress, but in this instance item 311 was a blue cocktail dress, the user may add a modifier requesting the system to provide a consumer choice model featuring red cocktail dresses. This request may be commanded by text such as “311 in red”, navigating and shifting the consumer choice model from container block 301 to container block 304, wherein container block 304 features items 314, 315, and 316 representing three red cocktail dresses in this exemplary instance. Container block 304 is on a separate branch than container blocks 301, 302, and 303 based on the modifier entered by the user. The user may now navigate similarly to methods disclosed and described in FIGS. 3A-B on this separate branch. It should be noted that the item numbers described herein are provided for ease of understanding, however since it is a particular advantage of the invention to provide a three-choice consumer model, each of the three items presented in a container block will always be referred to as item 1, item 2, and item 3, or simply 1, 2, and 3.

Referring now to FIG. 3D, the user may navigate to an additional branch based on an additional modifier, providing the user with a new consumer choice model based on the additional modifier. For instance, if container block 304 features items 314, 315, and 316 representing three red cocktail dresses, the user may add a modifier requesting the system to provide a consumer choice model featuring red cocktail dresses similar to item 315 but less expensive. This request may be commanded by text such as “315 but cheaper”, navigating and shifting the consumer choice model from container block 304 to container block 301, wherein container block 301 features items 317, 318, and 319 representing three red cocktail dresses similar to item 315, but less expensive in this exemplary instance. The user may now navigate similarly to the methods disclosed and described in FIGS. 3A-B on this additional branch. Alternatively, the user may request to purchase an item if desired. Purchasing an item can be done by text command, such as “buy item 318” or a purchase button may be provided. Likewise, default modifiers, including but not limited to “cheaper” and “similar” may be provided to the user in a button interface element. The user may also access and purchase the item by navigating directly to the item's source location by selecting a hyperlink as well known in the art.

In some embodiments, in each instance the consumer choice model is presented, data points are saved forming a user history profile. Users may navigate their user history profile and access previous consumer choice models, or view other choice models available in a specific historical data point, wherein the other choice models would be presented to the user in the same three choice model container as described and illustrated herein at the specific historical data point. Users may continually view all consumer choice models at any data point presented in the previously disclosed format. User history profiles may be viewed, edited, shared, linked, saved, referred and sent to other users for comparison, editing, modifying, or further customization in order for the system to provide the best match recommendations and other personalization for users. Likewise, items presented in any consumer choice model may be saved, shared, referred and sent to other users via text messaging, image, link, message attachment, message body, or any neural or physical device transmission. The saved choices may be modified by the user or if given permission by another user to be used for other purposes, including but not limited to viewing, editing, modifying, purchase decisions, sales transactions, sales check out, or other actions. In some embodiments, users may implement automatic decision making features, wherein the saved choices and modifications are passed into automated machine software which is authorized to transmit the decisions of the user autonomously.

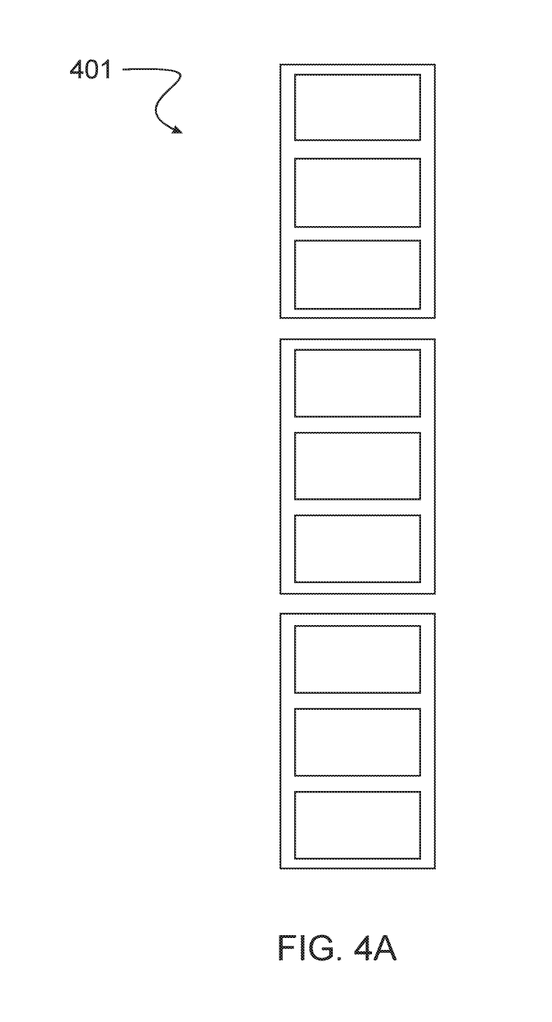

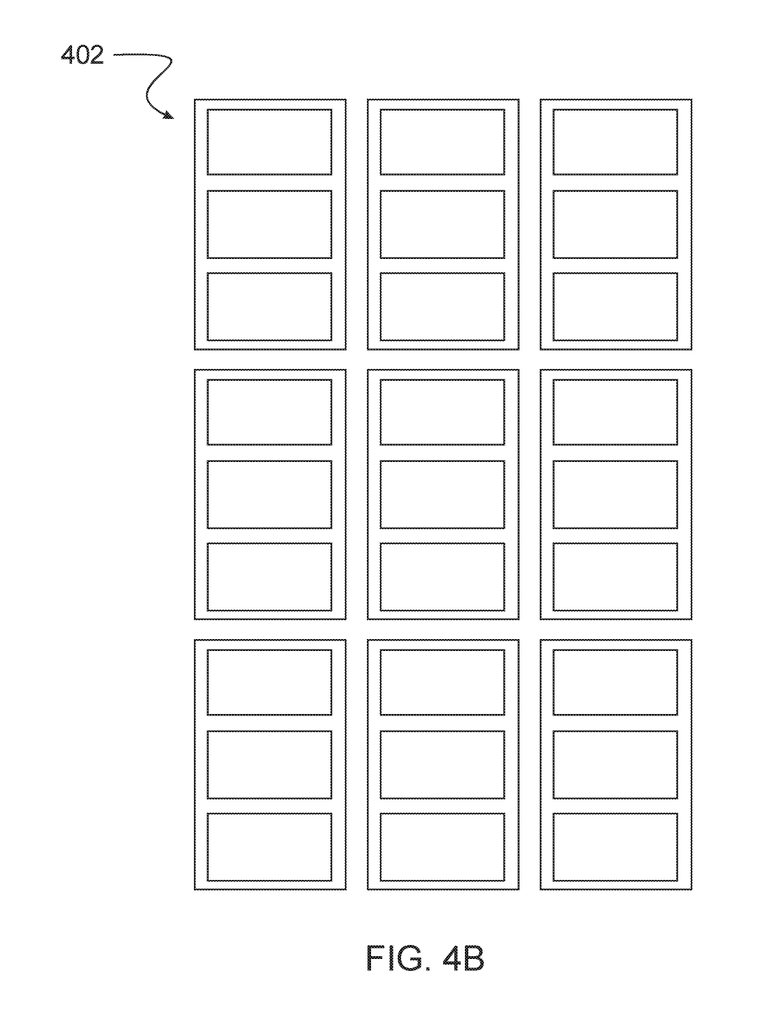

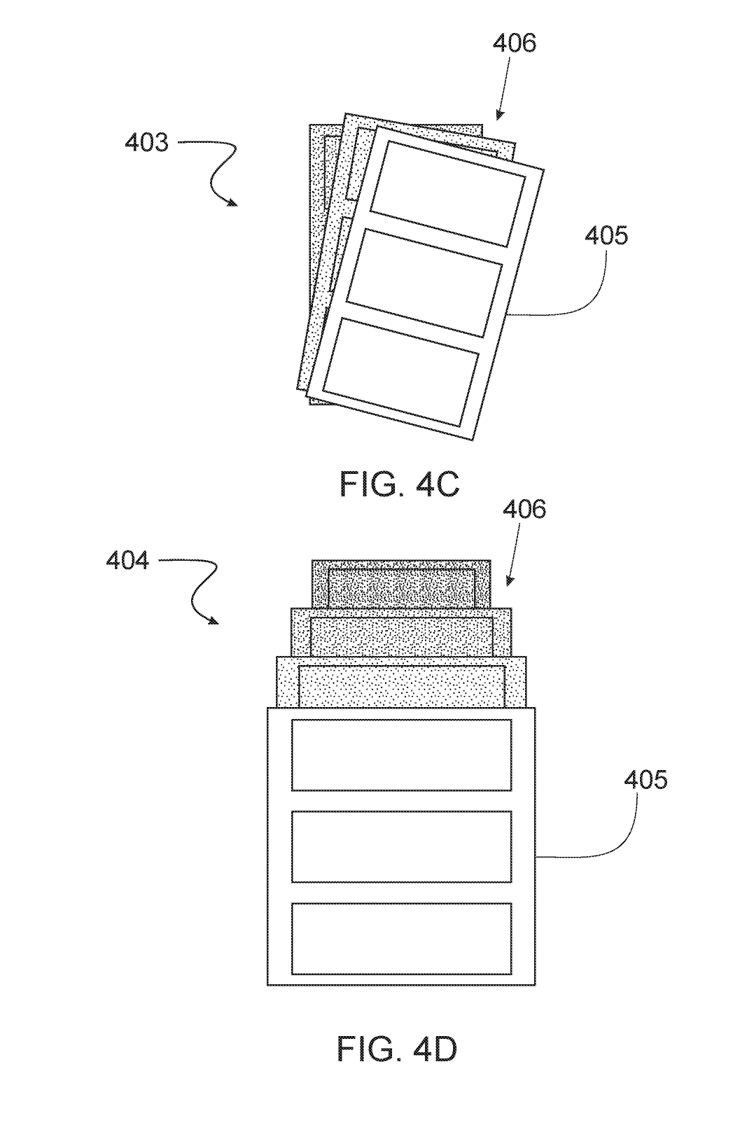

FIGS. 4A-D are exemplary diagrams illustrating methods for consumer choice modeling layouts according to an embodiment of the present invention. The consumer choice model or containers may be presented to users in a plurality of layouts. A stream layout 401 may be presented to the user as illustrated, wherein a user may navigate between container blocks in the stream layout as illustrated and described in FIGS. 3A-D. In some embodiments, a grid layout 402 may be presented to the user featuring a plurality of containers presented in a grid, wherein containers are presented in vertical and horizontal arrays as illustrated. In alternative embodiments, the consumer choice model or containers may be presented to a user in a stack layout. A stack with hidden series 403, presents a stack of containers wherein only a featured container 405 is visible and other containers 406 are hidden until the user navigates through the stack. Alternatively, a stack with a visible series 404 presents a stack of containers wherein both the featured container and the other containers are visible. The stack layouts are useful when a user is accessing the system from a device having a small screen, such as a mobile phone, creating a visually appealing layout for scrolling through consumer choice models. It should be understood, that other layouts may be utilized without departing from the spirit of the invention. Generally, the layout may change depending on the user device used. In other embodiments, users may select a specific layout if desired.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

In addition, reference to “first,” “second,” “third,” and etc. members throughout the disclosure (and in particular, claims) are not used to show a serial or numerical limitation but instead are used to distinguish or identify the various members of the group.

What is claimed is:

1. A method comprising steps:
(a) providing a search query to a user, wherein the user enters an item into the search query;
(b) presenting the user with a consumer choice model, wherein the consumer choice model is a three choice model comprising a first container block having first item, a second item, and a third item;
(c) navigating through a plurality of three choice models via a plurality of commands; and
(d) selecting an item.

2. The method of claim 1, wherein in step (a), the item may be a choice the user is deciding between including but not limited to products, objects, actions, persons, or interactive cards.

3. The method of claim 1, wherein in step (b), the consumer choice model may be presented in a plurality of layouts, wherein the plurality of layouts include a stream layout, a grid layout, a stack layout, and a stack layout with hidden series.

4. The method of claim 3, wherein any of the plurality of layouts may be selected by the user.

5. The method of claim 1, wherein in step (c), the plurality of commands include direct navigational commands and modifier commands.

6. The method of claim 5, wherein direct navigational commands allow the user to navigate between the plurality of three choice models, wherein navigational commands comprises text commands and gesture commands.

7. The method of claim 5, wherein the modifier commands includes text commands to narrow down a potential range of options, limiting the plurality of three choice models to include items which match the potential range of options.

8. The method of claim 1, further comprising a step of saving data points forming a user history profile, wherein the user history includes a history of the plurality of three choice models which were presented to the user and the data points are saved to a data repository on an Internet-connected server.

9. The method of claim 8, wherein the user history profile may be viewed, edited, shared, linked, saved, referred, and sent to other users.

10. The method of claim 1, wherein in step (b), the consumer choice model is defined by an algorithm, wherein the algorithm is based on a plurality of factors included but not limiting to the user's purchase history, product reviews, product ratings, product details, price points, other user search results, and randomization.

11. The method of claim 1, wherein in step (d), the selected item may be purchased.

12. A system comprising:
an Internet-connected computerized appliance having a processor and coupled to a data repository, the processor executing software from a non-transitory medium, the software providing an interactive interface to a consumer choice model, the system enabling a user to:
search for an item;
navigate through a plurality of three choice models via navigational commands;
narrow down potential options of the plurality of three choice models using modifier commands;
save search history into a user history profile; and
select an item.

13. The system of claim 12, wherein the item may be a choice the user is deciding between including but not limited to products, objects, actions, persons, or interactive cards.

14. The system of claim 12, wherein the consumer choice model may be presented in a plurality of layouts, wherein the plurality of layouts include a stream layout, a grid layout, a stack layout, and a stack layout with hidden series, wherein any of the plurality of layouts may be selected by the user.

15. The system of claim 12, wherein the selected item may be purchased.
